(19) United States
(12) Patent Application Publication
(10) Pub. No.: US 2002/0087398 A1
(43) Pub. Date: Jul. 4, 2002

(54) Method for making on-line pop promotion advertisement to manage distribution

(76) Inventor: Lee Chun-Yen, Chung Ho City (TW)

Correspondence Address: BACON & THOMAS, 4th Floor, 625 Slaters Lane, Alexandria, VA, 22314-1176, US

(21) Appl. No.: 09/749,891

(22) Filed: Dec. 29, 2000

(51) Int. Cl. G06F 17/60

(52) U.S. Cl. 705/14

(57) ABSTRACT

A method for making on-line POP advertisement designs used to manage distribution, it applies the system of computer network to design, fabricate and print the related POP promotion advertisements on-line (such as posters, propagating leaflets, promotion cards etc.) and manages propagating of selling of the distributors or branch stores. It is characterized by taking advantage of the network connecting technique to provide various sampling accessories and finished drafts in a database of a host or SERVER computer of the network for specific customers to make POP promotion propagandas; CLIENT computers at the specific customer's terminals use the browsers of the network to edit and organize an integrate on-line POP promotion propaganda as desired, and to provide the propaganda for users to download and print, an object of helping and teaching users to deal with propagating advertisements for selling business thus is obtained.

### BACKGROUND OF THE INVENTION

1. Field of the Invention

The present invention is related to a method for making on-line POP advertisement designs which can be used to manage distribution, and for applying the system of computer network to design, fabricating and printing the related POP promotion advertisements on-line and managing propagating of selling of the distributors or branch stores.

2. Description of the Prior Art

POP (Point of Purchase) promotion propagandas (such as with posters, propagating leaflets, promotion cards etc.) are applied by big chain stores such as department stores (e.g. SOGO DEPARTMENT STORE, SHIN KONG DEPARTMENT STORE), malls (e.g. CARREFORE, MACRO) and retail dealers (e.g. WATSON, WELLCOME SUPERMARKET). Whenever the abovementioned dealers want to promote purchasing by providing commodities of special prices or to hold a promotion activity to increase selling achievement, the so-called POP promotion advertisements become the best weapons for propagation. Consumers often go to stores which provide inexpensive commodities or attractive discount advertisements, this makes the stores larger selling amount. In view of this, POP promotion advertisements are really the very important factor for commercial sales. Thereby, big chain store owners pay additional expenditure for making POP promotion propagandas or hire professional art designers to do them.

On the contrary, in conventional selling markets or paths, there are hardly applications of promotional strategies; whenever selling seasons come, waste of manpower and material induced by heavy and complicated promotion activities and preparing works often do not get the expected market reaction due to delaying which result coarse POP promotion propagandas. The reasons mostly reside in insufficient fund which makes inability to compete with big chain markets, especially in making exquisite POP promotion propagandas and propagation.

Therefore, no matter they are conventional selling markets or paths or big chain markets, they have some difficulty in making POP promotion propagandas. Nowadays, INTERNET network goes more and more prosperous, a lot of consumers have known from the exquisite POP promotion propagandas of each selling market on the network; contrarily, common owners and owners of big chain markets doing business through conventional selling paths shall think about taking advantage of the convenience of the network, and shall take advantage of the specific functions of the computer network to save personnel expenditure in making exquisite and effective POP promotion propagandas to thereby increase profits of business.

### SUMMARY OF THE INVENTION

In view that the process in producing the conventional exquisite POP promotion propagandas not only consumes large amount of manpower and material, but also result non uniform qualities; the inventor of the present invention studied and developed a method for making exquisite on-line POP advertisement designs taking advantage of network. Especially in the digitalization times today, one who can hold efficiency and speed of business will be saved from elimination in the digital flood. Therefore, the present invention has the best advantage that a selling strategy is integrated through the technique of computer network, and all the resources or all the branch stores of an enterprise can operate through the management platform of a digitalized network established by the present invention to easily and effectively integrate the goods in stock with selling, especially in the complicated works of distribution of POP promotion propagandas, remote output, information interflow, file management etc., in a way more effectively reduces unnecessary management and human power effort. So that the managers can have any strategies fast and perfectly appeared at the first chance at every branch store or branch market, to synchronically provide convenience for digital management, and to actually control the time efficiency in selling.

In particular, the “method for making on-line POP advertisement designs to manage distribution” of the present invention is for applying the system of computer network to design, fabricating and printing the related POP promotion advertisements on-line and managing propagating of selling (such as posters, propagating leaflets, promotion cards etc.) for the distributors or branch stores. It is characterized by taking advantage of the network connecting techniques, to provide various sampling accessories and finished drafts in the database of a host or SERVER computer for specific customers to make POP promotion propagandas. CLIENT computers at the specific customer's terminals can use the browsers of the network to edit and organize an integrate on-line POP promotion propagandas as desired, and print the finished propagating posters taking advantage of the network downloading. Thereby, an object of helping and teaching users to deal with the propagating advertisements for selling business can be obtained.

The primary object of the present invention is to apply the system of computer network to render users to edit promptly on-line POP propagandas according to requirements of design on the CLIENT computers with the database of POP exquisite drafts and the operation software provided by the SERVER computer, and integrate POP promotional propagandas can thus be obtained. And propagating posters can be downloaded from the network for printing to form desired advertising works, thereby, changes in the markets can be promptly given with a reaction in adjusting selling items, and selling achievement can be increased; users can be taught with dealing with sales business on the network, and an object of all people learning aesthetics can be obtained.

The secondary object of the present invention is to apply the POP promotional propagandas made through the network and cooperate in due time with the remote branch store management and file management systems of the present invention to assist management of the stocks and selling propagation of the branch stores. So that all the stores have the same series of promotional propagandas which make them more programmatic and effective, and can mate with marketing changing faster for adjusting selling items and positively influencing selling achievement.

Another object of the present invention is to make the SERVER computer provide the application technique of software to render users to edit, freely reduce, expand and change drafts in the browsers of the network in reference to the process flow of fabricating and editing drafts of the conventional designers without setting up any software in advance to make more exquisite POP promotional propagandas.

Besides, when users edit and organize to obtain integrate POP promotional propagandas through the network according to requirements of design in application the browsers of the network on the CLIENT computers, they can also save the file downloaded from the network for printing it to form desired propagating posters.

The present invention will be apparent after reading the detailed description of the preferred embodiment thereof in reference to the accompanying drawings.

### BRIEF DESCRIPTION OF THE DRAWINGS

FIG. 1 is a schematic view showing a connecting construction of the INTERNET network;

FIG. 2 is a flow chart of the membership system of the present invention;

FIG. 3 is a schematic view showing a database with various accessories and samples in an entry of a web page of the present invention;

FIG. 4 is a schematic view showing operation of a kind of software provided by a SERVER computer of the present invention;

FIG. 5 is a schematic view showing the present invention expressed through the INTERNET network on the web page.

### DETAILED DESCRIPTION OF THE PREFERRED EMBODIMENT

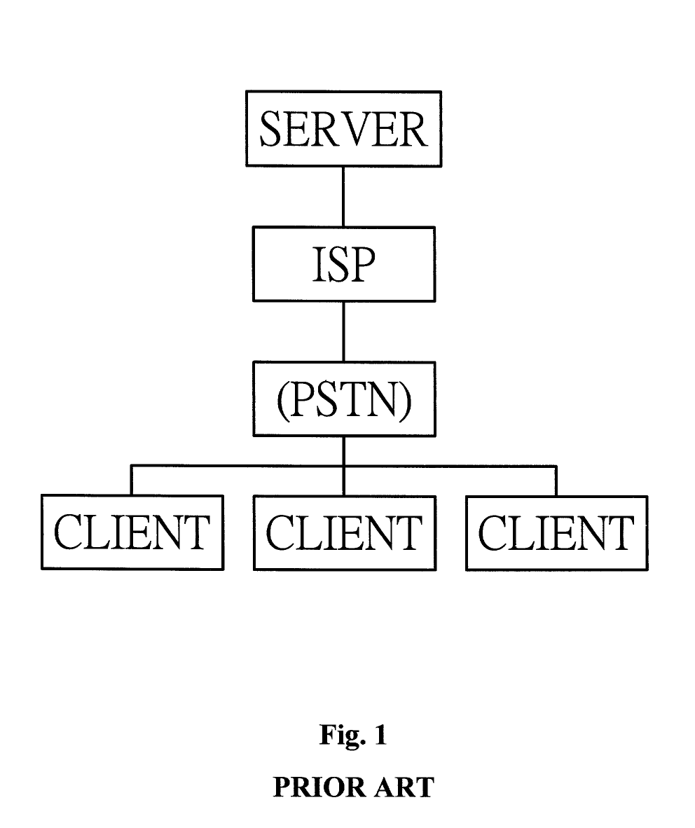

Referring to FIGS. 1 to 5, the present invention provides a method for making on-line POP advertisement designs which can be used to manage distribution, and for applying the system of computer network to design, fabricating and printing the related POP promotion advertisements on-line (such as posters, propagating leaflets, promotion cards etc.) and managing propagating of selling of the distributors or branch stores. It is characterized by taking advantage of the network connecting technique, to provide various sampling accessories and finished drafts in the database of the host or SERVER computer for specific customers to make POP promotion propagandas. The CLIENT computers at the specific customer's terminals can use the browsers of the network to edit and organize an integrate on-line POP promotion propagandas as desired, and print the finished propagating posters taking advantage of the network downloading. Thereby, an object of helping and teaching users to deal with the propagating advertisements for selling business can be obtained.

The network connecting technique is as shown in FIG. 1, wherein, CLIENT computers are connected to the network via the repeater servos of the PSTN and ISP, or via the wideband cable, and are connected to the SERVER computer of the network of the present invention. This is a conventional technique, and is not further described.

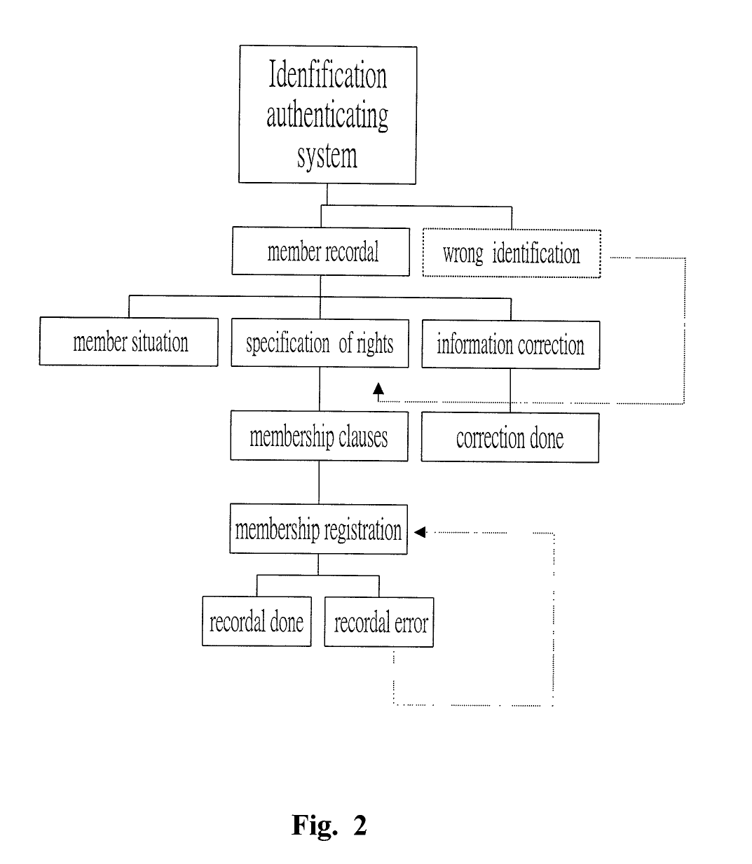

As shown in FIG. 2, the abovementioned “specific customers” are established by a membership system, i.e., the CLIENT terminals must have an identification of member for entering the database of the SERVER computer for editing on-line. Thereby, the present invention has a set of identification authenticating system which has a flow process expressed on a web page as shown, and includes: member registration, member situation, specification of rights and information correction. When in signing for registration, the SERVER computer executes checking examination, if the identification of a member is wrong, the selection items of membership clauses, membership registration and recordal etc. will appear in the specification of rights to request the member to register again or to ask a non-member to joint the membership.

When the users of the above stated CLIENT terminals do POP on-line editing according to requirement in applying the browser interface, the SERVER computer of the present invention must include two primaries, one for establishing a database with various accessories and samples required for fabricating POPs, the other being the operation software for the on-line editing. Both shall be provided for users to operate on the web page.

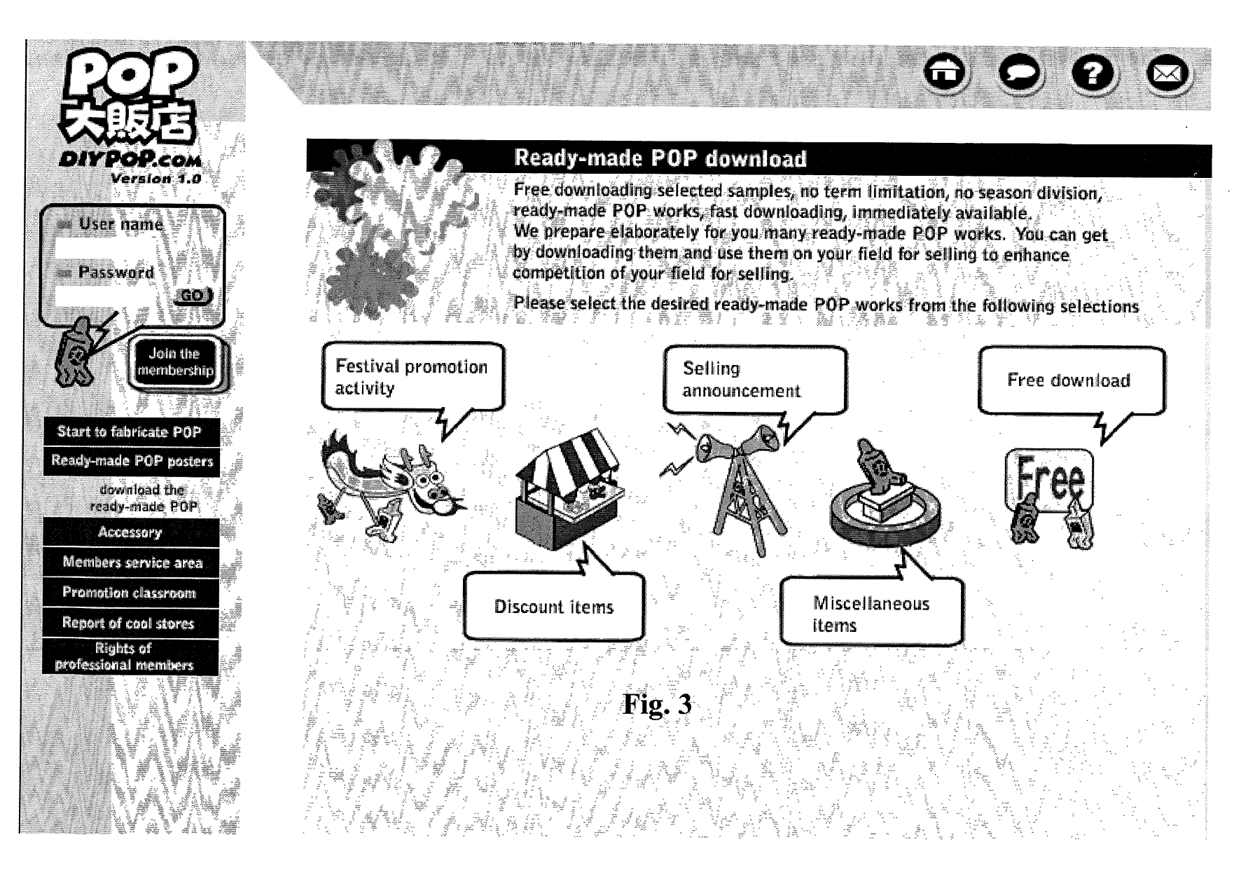

The above stated database with various accessories and samples required for fabricating POPs is as shown in FIG. 3, and includes various posters, prices, promotion discounts, festival slogans, hanging sampling tabs, logos etc. which are often used on accessories of the subject of POPs. Users can select the accessories out of the selections of web pages or by searching; or can transmit upwardly the posters, drawings of the goods, mark of a company etc. in order to composite a desired POP. And users can also transmit upwardly the finished POP to the database for storing as a sample for edition afterwards.

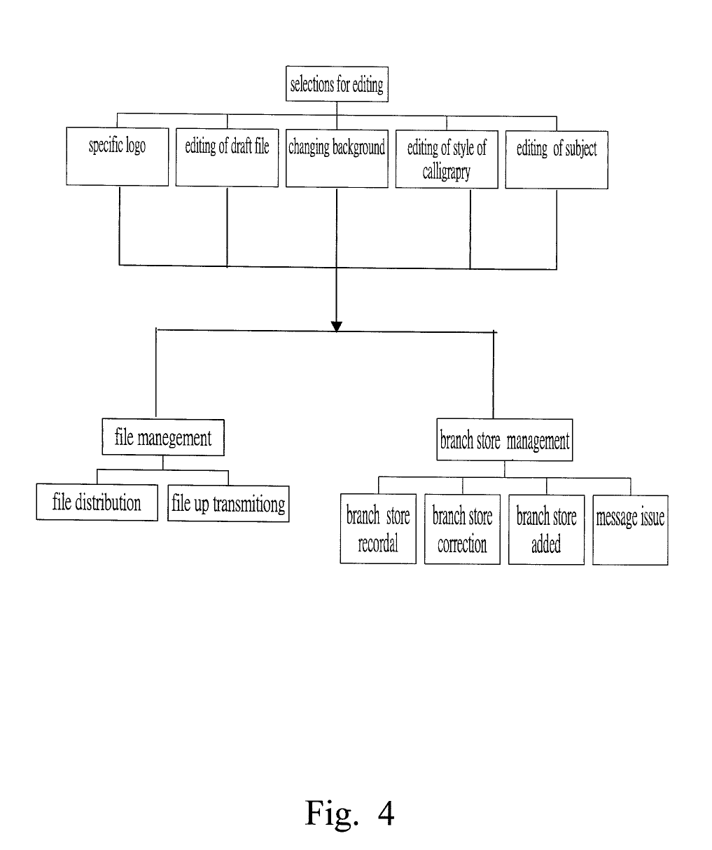

As shown in FIG. 4, the operational software for on-line edition of the present invention mainly provides various selection items for users on web pages, in order that various accessories stored in the database can be used to edit and form integrated POPs. The function of on-line edition includes mainly: edition of headings, edition of styles of calligraphy, changing of background, edition of draft files etc. After entering the selections, the operational software will lead the users to back to the aforesaid accessories before selection in the database, and will provide the functions of dragging, random enlargement, reduction of the subject matter, changing the sequences of the matters etc. (moving to the upper layer, moving to the lower layer, moving to the uppermost layer and moving to the bottommost layer etc.) to complete edition.

As to the content of the operational software for the abovementioned database and on-line edition, the present invention not only integrates more than ten thousand professional draft source materials for fabricating POP promotion propagandas, and by planning for more than 30 important selling periods or terms all over an year, to render the complicated editing process of posters with drawings and words used before able to become easy and fast through integration of the digital technique of computer network. And the Know How techniques of conventional difficult promotional strategies and complicated printing etc. can be completed soon. In this way, the original professional process in fabricating POP promotion propagandas can be done by any one easily; this can effectively reduce unnecessary operation cost of a businessman.

Besides, the present invention can also provide the function of management of branch stores for specific customers having several branch stores. The information of stocks and selling management strategy of the general store can be used in adjusting the promotion pace directly; and the computer file of POP promotion propagandas completed by the general store can be downloaded for printing at any time, so that all the branch stores can have the POP promotion propagandas of the same series, and promotion propagation can be more programmatic and effective and can mate with marketing changing faster for adjusting selling goals and positively influencing selling achievement. The computer file of POP promotion propagandas completed by the general store downloaded for printing can reduce personnel expenditure in making POP promotion.

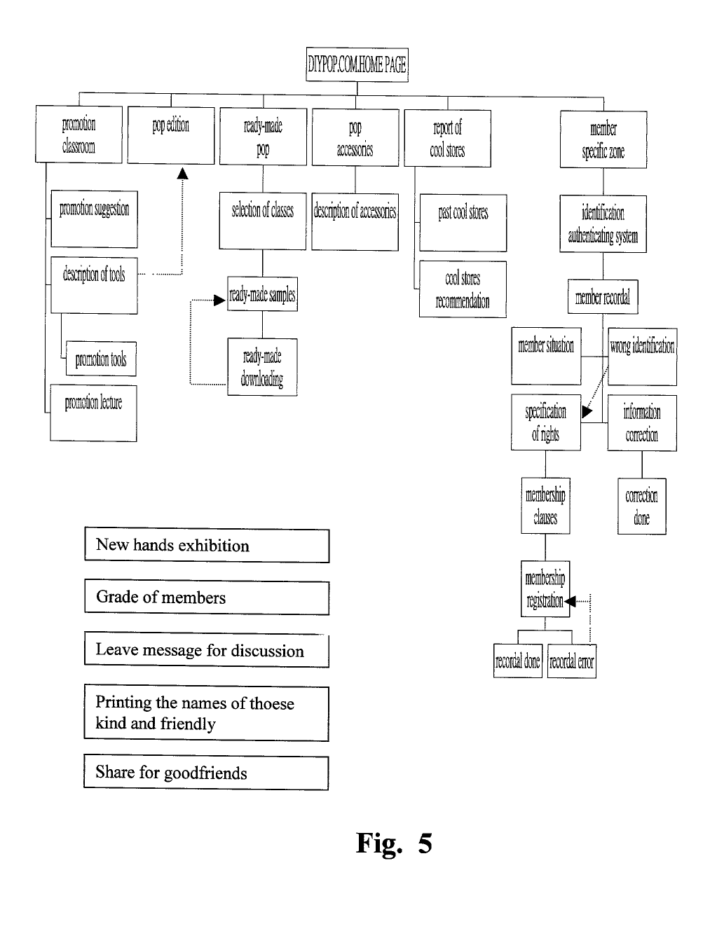

The method in fabricating POPs by applying the computer network of present invention can have the flow process as shown in FIG. 5 when it is expressed on a web page.

Wherein, “member specific zone” is the aforesaid membership system for specific customers selected.

“Ready-made POP”, “POP accessories” are exactly the aforesaid accessories and samples provided in the database of the SERVER computer.

“POP edition” is the aforesaid operational software for editing.

In the drawing, there are selections such as “Promotion classroom”, “Report of cool stores”, “New hands exhibition”, “Grades of members”, “Leave messages for discussion”, “Printing the names of those kind and friendly”, “Share for good friends”, they are all added functions provided in a normal web page. For example, “Promotion classroom” mainly provides the information such as explanation of POP and importance of POP etc.; “Report of cool stores” is providing of some special stores for users by the SERVER terminal of the network; while “Share for good friends” allows e-mail sending out from the web page of the present invention. The selections in the web page are not the technical characteristics of the present invention; they are not described further.

In conclusion, the present invention successfully provides a method for making POPs applying the system of computer network; especially successfully introduces an electronic commerce mode into the field of advertisement design, thus it provides a brand-new idea and commercial measures for the field of sales business or advertisement design. The above statement is only for illustrating a preferred embodiment of the present invention, and not for giving any limitation to the scope of the present invention.

It will be apparent to those skilled in this art that all equivalent modifications and changes without departing from the spirit and principle of the present invention shall fall within the scope of the appended claims and are intended to form part of this invention.

Having thus described my invention, what I claim as new and desire to be secured by Letters Patent of the United States are:

1. A method for making on-line POP advertisement designs used to manage distribution, said method is characterized by taking advantage of the network connecting technique to provide various sampling accessories and finished drafts in a database of a host computer of a network for specific customers to make POPs, the CLIENT computers at the specific customer's terminals use the browsers of said network to edit and organize an integrate on-line POP promotion propaganda as desired, and to provide said propaganda for users to download and print, an object of helping and teaching users to deal with propagating advertisements for selling business thus is obtained.

2. A method for making on-line POP advertisement designs used to manage distribution as in claim 1, wherein, said host computer of a network has a branch store management system to assist management of stocks and selling propagation of branch stores; and POP promotion computer files completed by a general store are distributed to and downloaded by said branch stores for printing, propagating to complete the object of promotion of said general store.

3. A method for making on-line POP advertisement designs used to manage distribution as in claim 1, wherein, said host computer of a network further has a membership system.
